(19) United States
(12) Patent Application Publication
(10) Pub. No.: US 2011/0231913 A1
(43) Pub. Date: Sep. 22, 2011

(54) SYSTEM AND METHODS OF DETERMINING COMPUTATIONAL PUZZLE DIFFICULTY FOR CHALLENGE-RESPONSE AUTHENTICATION

(75) Inventors: Wu-chang Feng, Portland, OR (US); Ed Kaiser, Bellevue, WA (US)

(73) Assignees: State of Oregon acting by and through the State Board of Education on Behalf of Portland State; University, Portland, OR (US)

(21) Appl. No.: 13/050,123

(22) Filed: Mar. 17, 2011

Related U.S. Application Data
(60) Provisional application No. 61/314,877, filed on Mar. 17, 2010.

(51) Int. Cl. G06F 21/20

(52) U.S. Cl. 726/7

(57) ABSTRACT

Computational puzzles are parameterized by a difficulty variable which may be assigned based on at least one component from the group of components: time component, location component, reputation component, usage component, content component, and social networking component. For example, in one embodiment, the proof-of-work puzzle comprises a location component directed by the geographic location of the client that can be applied to any web transaction or application. One such application involves online ticket sales including those that employ purchasing robots. Another application involves accessing and using webmail.

This application claims the benefit of U.S. Provisional Application No. 61/314,877 filed Mar. 17, 2010.

### FIELD OF THE INVENTION

The invention relates generally to computer security. More particularly, the invention relates to challenge-response authentication relating to cryptographic puzzles—or proof-of-work puzzles—whose difficulty is based on one or more time component, location component, reputation component, usage component, content component, and social networking component.

### BACKGROUND OF THE INVENTION

Challenge-response authentication is a security measure used in computer systems. More specifically, challenge-response authentication is a family of protocols that authenticates a client or server in order to provide access to various information. For example, a server presents a challenge such as a question to a client whereupon the client must provide a valid response in order to access certain information. Challenge-response authentication attempts to prevent a denial-of-service (“DoS”) attack or distributed denial-of-service (“DDoS”) attack. These attacks attempt to make a computer resource unavailable to its intended users. Typically, DoS and DDoS attacks consist of the concerted efforts to prevent an Internet site or service from functioning efficiently or at all.

The simplest example of a challenge-response protocol is password authentication, wherein the challenge—or puzzle—is asking for a secret value such as a password and the valid response is the correct password.

Challenge-response protocols are also used to assert things other than knowledge of a secret value. Currently, CAPTCHAs (“Completely Automated Public Turing test to tell Computers and Humans Apart”) exist as a type of puzzle challenge in the application layer. CAPTCHAs are used in computer systems to determine that the client is not run by a computer or, in other words, that the viewer of information such as web or Internet content is a real person. CAPTCHAs are automated Turing tests that typically consist of skewed representations of letters and numbers. A user must correctly interpret the characters before being granted service. A common type of CAPTCHA is shown in FIG. 1 and requires that a user visually verify a distorted image that appears on the screen, usually an obscured sequence of text such as letters or digits. The user verifies the distorted image by typing in that sequence of text. The distorted image is designed to make optical character recognition (“OCR”) difficult thereby preventing a computer program from passing as a human user.

CAPTCHAs are used to prevent automated software from performing actions which degrade the quality of service of a computer system. The process involves one computer—a server—asking another computer—a client—to complete a simple test which the server is able to generate and grade. Because other computers are unable to solve the CAPTCHA, any client returning a correct solution is presumed to be operated by a human user.

CAPTCHAs can be used to slow down automated software known as a “purchasing robot”—otherwise termed herein “adversary”. Adversaries are designed to quickly purchase products or services over the World Wide Web. Using a CAPTCHA requires a human user to verify the distorted image thereby thwarting completely automated purchasing robots.

Event tickets are just one example where purchasing robots may be used. Currently, event tickets are a $30 billion market with a majority of the revenue coming from online purchases. For a number of reasons, tickets are sold as commodities with fixed prices. When tickets for popular events such as concerts go on sale online, they sell out almost instantly. One of the biggest problems in selling tickets online is ticket resale and the ability for people known as “scalpers” to instantly snatch up all available tickets so that they can resell them at substantially higher prices. Scalpers use automated software—purchasing robots—to get hundreds of tickets in the first moments of online sales, getting an advantage over fans trying to buy the same tickets. To deter automated ticket purchasing robots, vendors like TicketMaster® employ CAPTCHAs like the one shown in FIG. 1. In this instance, CAPTCHAs merely force purchasing robots to outsource the CAPTCHA solution to a human in order to purchase the majority of tickets to popular events. Since the profit associated with reselling tickets is several orders of magnitude larger than the cost associated with paying humans to solve the CAPTCHAs, the CAPTCHA approach has been ineffective.

CAPTCHAs have also been ineffective in preventing spam such as comment spam in blogs and protecting email addresses from spam crawlers. For example, to execute attacks using webmail services, spammers attempt to automate the creation of new accounts at free webmail sites such as Google GMail, Yahoo! Mail, and Microsoft's Live Mail, or they perform reputation hijacking by obtaining the login credentials for existing legitimate webmail accounts via methods such as spear phishing. Webmail services attempt to combat spam transmission through the use of CAPTCHAs, but there are several problems with using CAPTCHAs with webmail applications. CAPTCHAs create a terrible user interface experience especially to users that are visually impaired. Furthermore, increasingly more sophisticated optical character recognition algorithms are becoming available making it hard to generate CAPTCHAs that are easy for humans yet difficult for computers to solve.

While CAPTCHAs are intended to be solved by a human, Proof-of-work (“POW”) or Client Puzzle Protocol (“CPP”) are protocols or puzzles intended to be solved by a computer. POW protocols are typically implemented to deter DoS and DDoS attacks and other service abuses such as spam on a network. POW puzzles require some work from the client. A key feature of POW puzzles is their asymmetry: the work must be moderately hard for the client but easy to check for the server.

Numerous proof-of-work protocols or client puzzles have been proposed as an alternative solution to CAPTCHAs. POW forces clients to solve computational puzzles of client-specific difficulty before granting them service, acting as a filter for users based on their willingness to commit their own resources. Proof-of-work does not impose user interface problems and is based on cryptographic primitives that are provably hard to bypass. In addition, the challenge difficulty is adaptable on a per-user or per-request basis. A number of proof-of-work systems have been proposed to protect network protocols, transport protocols, authentication protocols, web protocols, and email. Unfortunately, proposed proof-of-work approaches have met resistance to deployment because they suffer from numerous shortcomings.

Hash-based puzzles are based on puzzles that require a client to reverse a weakened cryptographic hash function. While hash-based puzzles are very efficient to implement, they have several drawbacks. Specifically, such puzzles are easily parallelizable across multiple machines and have probabilistic solution-times that are not predictable. In addition, the difficulty settings on many hash-based puzzles are coarse, making it hard to control the amount of work assigned to a client.

Simplistic difficulty setting puzzles do not differentiate adversaries from legitimate clients and are thereby easily defeated. Most proof-of-work systems set the difficulty using a single metric such as the load on the system, the request rate of the client, the demand for the service, or the content of the request. Without sufficient defense-in-depth, it is unlikely such systems will deter all automated adversaries.

Client software modifications require adoption of special client software to receive proof-of-work challenges and solve them on behalf of the client.

Proof-of-work protocols force clients to commit arbitrary resources as determined by the server before being allowed access to the server. Managing the difficulty of proof-of-work puzzles is critical to their effectiveness. Certain uniformly applied proof-of-work puzzles are inadequate against adversaries thereby overly penalizing legitimate clients. Certain other proof-of-work puzzles can be adapted to issue more difficult puzzles to potential adversaries. While this approach can isolate adversaries, even those with significant resources, from legitimate clients, issuing puzzles with varying difficulty has remained an open challenge.

Current proof-of-work systems take a simplistic approach for setting the difficulties of the puzzles they issue, making them ineffective. One policy used by many proof-of-work systems is to have the server issue puzzles with uniform difficulty across all clients whenever it becomes overloaded. Another policy used is market-based where clients “bid” on the service by solving computational challenges that are based on how much they value the service. The service then processes requests in a priority order based on the amount of work committed by each client. Unfortunately, policies that treat clients uniformly have been shown to be ineffective. Such systems unfairly penalize legitimate clients while having minimal impact on adversaries that control a significant amount of resources such as a botnet.

More sophisticated proof-of-work systems tailor the difficulties of puzzles to individual clients to incentivize good behavior. For example, in one application, a counting Bloom filter is used to track the usage of individual clients over time. When the server is overloaded, harder puzzles are delivered to clients that have sent a large number of requests to the server recently. In another application, the mail server determines the difficulty of the puzzle based on how “spammy” the message a client is attempting to send appears. Unfortunately, both systems provide disincentives only for specific misbehavior and are vulnerable to alternative attacks. Specifically, the request-based approach does not provide disincentives to an adversary posting web comment spam at a reasonable rate while the content-based approach does not provide disincentives against an adversary attempting to take down the service with a flood of requests. To address the shortcomings of previous approaches, a comprehensive framework is needed that adaptively delivers puzzles with difficulties that are based on a range of characteristics about the client and the request.

Therefore, the need exists for improved challenge-response authentication such as proof-of-work puzzles whose difficulty is determined by a range of characteristics such as time, location, reputation, usage, content, or social networking, and furthermore, the need exists for proof-of-work puzzles that can be deployed without modifications to client or server software.

### SUMMARY OF THE INVENTION

The invention is a computer system method for setting the difficulty of a computational puzzle or challenge that a client must solve before granting access to information. The term “information” includes, for example, a service, a product, or any Internet site, World Wide Web transaction or network application.

The present invention uses a more-efficient construction of the time-lock algorithm to issue non-parallelizable, fine-grained puzzles that have deterministic solution-times. In addition, a comprehensive set of metrics is used for determining puzzle difficulties to provide significant disincentive for spammers. Finally, the present invention is implemented using standard web scripting environments allowing it to be deployed without modifications to either the client or server software.

The present invention provides for fast generation and verification. Issuing the puzzle and verifying the correctness of subsequent answers adds minimal computation and memory overhead in order to prevent the proof-of-work mechanism from becoming a target for attack. Furthermore, the present invention is not parallelizable, that is, it is not possible to break up the work into smaller components that can be solved across many machines simultaneously. The present invention also includes a deterministic run-time—the amount of computation a client is required to consume is predictable and deterministic in order to ensure consistent client operation. The present invention also supports difficulties that can be finely controlled in order to match the amount of work a client performs with the level of protection a server might require.

Proof-of-work or client puzzle systems consist of three distinct parts. The issuer generates and delivers a puzzle to the client on behalf of the server. The solver generates solutions to puzzles received by the client. The verifier denies or accepts solutions sent to the server based on their freshness and validity. In the proof-of-work model, all clients are considered adversaries, but of varied maliciousness. Based on their current and past behavior, they are then issued puzzles of appropriate difficulty. The puzzle difficulty is expressed in terms of units of work, which are uniform-length computations such as the execution of a hash function. A proof-of-work scheme alters the operation of a network protocol so that a client must return their puzzle along with a correct answer before being granted service. If the server receives a request without a valid puzzle or an incorrect answer, the request is ignored and a valid puzzle is sent to the client. The puzzle given to the client has a difficulty setting that determines how much computation it must perform before generating an answer. After receiving and solving the puzzle, the client attaches both the puzzle and answer when resending the request. Upon receiving the answer, the server verifies its correctness before allowing the client access.

According to the present invention, the algorithm that issues and verifies the client is based on a novel construction of time-lock puzzles. Time-lock puzzles are based on repeated squaring, a sequential process that forces the client to compute in a tight loop for an amount of time that is precisely controlled by the issuer, otherwise referred to herein as “server”. Time-lock puzzles are non-parallelizable and have deterministic runtimes. Although the cost of generating time-lock puzzles is prohibitively expensive for use in high-speed network protocols and services, the present invention efficiently and securely generates multiple puzzles from a single puzzle.

The invention efficiently issues and validates multiple proof-of-work computational puzzles from a single proof-of-work puzzle, specifically a time-lock puzzle. The issuer or server generates p and q, two large prime numbers as well as a difficulty t that determines the amount of work a client must perform. The server then calculates the modulus n=p×q, randomly selects a number a, and sends the client a, t, and n. The client must then return an answer A such that A=a^{(2̂t)} mod n. The server can check that A is correct by performing a short-cut computation φ=(p−1)×(q−1), r=2^{t} mod φ, and A′=a^{r} mod n. If A matches A′, then the client has performed the computation accurately.

The present invention modifies the time-lock puzzle generation component so that a single pair of prime numbers can be used to generate multiple client puzzles in a consistent fashion thereby allowing the system to operate with constant state and amortize the cost of generating the prime numbers across many issued puzzles.

The present invention modifies time-lock puzzles by setting t based on the maliciousness of the client and by modifying the generation of a. Instead of selecting a randomly, the algorithm generates a as a cryptographic hash of client characteristics f_{c}( ) and a periodically updated random server nonce K. For example, a=SHA1(K f_{c}( )) where f_{c}( ) can consist of any number of client parameters including the URL being requested, the IP address of the client, and the difficulty of the puzzle given to the client. More specifically, a=SHA-1 (f(client)∥IP(client)∥K(server)) where IP(client) is the Internet Protocol address of the client.

Rather than incur the overhead of generating large prime numbers for each puzzle, a new puzzle can be issued by performing a single cryptographic hash. In addition, the verifier only needs to keep track of K, p, and q in order to properly validate subsequent puzzle answers from the client since it is able to regenerate t and fc( ) from the client's request.

The cryptographic strength of the modified time-lock algorithm is configurable to match its use in this context. Because the cryptographic mechanism is expected to be broken on the order of several seconds to minutes and because the keys themselves can be easily regenerated during operation, it is possible and desirable to use “weak” cryptographic keys for efficiency. The two main parameters that drive the modified algorithm are the size of the prime numbers used to generate subsequent time-lock puzzles and the frequency in which those keys are regenerated. The size of the prime numbers determines the scheme's resistance to a brute-force attack that seeks to factor n into the prime numbers p and q.

Computational puzzles are parameterized by a difficulty variable. The invention assigns the computational puzzle difficulty based on at least one component selected from the group of components comprising of: time component, location component, reputation component, usage component, content component, and social networking component.

The time component is any variable based on duration such as past, present, future, interval or period. In one embodiment, the time component may be the time elapsed since the creation of an account by the client on a web service. In another embodiment, the time component may be the time elapsed since the last request of the client. In another embodiment, the time component may be the time of day a request or message is sent. In yet another embodiment, the time component may be the difference in time the request or message is sent by the client. In another embodiment, the time component may be the typical time of day the client sends a request or message. In another embodiment, the time component may be the current time relative to a fixed time in the past or in the future.

With respect to webmail services, spammers tend to send messages non-stop throughout the day. Thus, the time component may be the time elapsed since an account's last message was sent, the time of day the message is sent, and the difference in time the message is sent and the typical time of day the account's owner sends messages can be used to indicate anomalous behavior and to issue more difficult puzzles. Another useful time component may be the time elapsed since the creation of the user's account on a webmail service. For example, accounts that are older and established are less likely to be sources of spam and can receive progressively easier puzzles compared to newly created accounts.

The location component is any variable based on a place, position, activity, or situation. In one embodiment, the location component may be the geographic location of the client. In another embodiment, the location component may be the geographic distance from the client to the server. In another embodiment, the location component may be the geographic distance from the client to other clients. In another embodiment, the location component may be the geographic distance from the client to other fixed geographic locations. In another embodiment, the location component may be the geographic distance from the client's current location to a client's typical location in accessing a site.

Turning to webmail services, the geographic location of a client obtained via geographic databases can often be used to determine whether or not the source is sending spam or not. For example, some spam is sent with specific geographic patterns while spam sent from accounts that have been spear phished will often originate from machines that have different geographic locations than the victim's typical location. Furthermore, for webmail services that serve local communities such as a university's student population, the geographic distance the client is from the server can roughly differentiate legitimate versus adversarial behavior.

The reputation component is any variable based on repute or recognized reliability. In one embodiment, the reputation component may be the reputation of the source Internet Protocol address the client is using as determined by other network entities that have interacted with it previously. In another embodiment, the reputation component may be the reputation of the client itself as determined by other clients.

One of the reasons spammers have turned to webmail is the widespread use of blocklists on mail servers. Since the IP addresses of many compromised machines are well-known, mail servers can be easily configured to block mail from them. In order to leverage this protection, network services can query a number of distributed IP address blocklists to determine the reputation of a client based on its address. Specifically, the presence of a client machine in any of these databases can be used to substantially increase the difficulty of the puzzle the client must solve before allowing access to a service.

The usage component is any variable based on the act of employing. Past and current usage of a client to drive puzzle difficulties can help disincentivize misbehavior. In one embodiment, the usage component may be the number of recipients the message or request will cause to be contacted. In another embodiment, the usage component may be the number of requests or messages the client has sent over an arbitrary time period in the past. In another embodiment, the usage component may be the current load on the entire computer system. In yet another embodiment, the usage component may be the number of messages the client has sent through an account that has not been classified as spam compared to the amount of e-mail messages the client has sent through the account that has been classified as spam.

With respect to webmail services, difficulties can be based on the total number of messages a client has sent in the past, the number of messages a client has sent in the past that has not been classified as spam, the number of messages a client has sent in the past that has been classified as spam, and the total number of recipients the message will be sent to. In addition, as with prior proof-of-work systems, the current load on the webmail system can also be used to drive puzzle difficulties in order to give the server an ability to throttle clients when overloaded.

The content component is any variable based on anything that is expressed through a medium. In one embodiment, the content component may be the format or structure of the message or request that the client is attempting to send. In another embodiment, the content component may be the reputation of the Uniform Resource Locator (“URL”) embedded in a message or request that the client is attempting to send. In another embodiment, the content component may be the reputation of an image embedded in a message or request that the client is attempting to send.

With respect to webmail services, distributed blocklists have been developed to collect such URLs in a database that can be queried in real-time. By querying such sources and automatically increasing the difficulty of puzzles given to clients attempting to send messages with such URLs embedded, one can thwart the ability of spammers to sustain spam campaigns.

The social networking component is any variable based on social involvement. In one embodiment, the social networking component may be based on whether the client is in the social network of the eventual recipient of the content and the social distance the client is away from the recipient. In another embodiment, the social networking component may be the reputation of the client in the social network of the recipient as determined by the recipient and the recipient's peers. In yet another embodiment, the social networking component may be based on whether the eventual recipient of the content of the request or message of the client has previously communicated with the client in the past.

Turning to webmail services, most spam is sent using email addresses that the recipient has never communicated with in the past or e-mail addresses that are not within the recipient's social network. Using social network connectivity and prior communication history to determine puzzle difficulty can reduce unnecessary computation for legitimate webmail clients.

It is contemplated that the present invention is applicable to a wide variety of web or Internet transactions and applications including those that currently employ CAPTCHAs, for example, web applications relating to webmail and online ticket sales including those that employ purchasing robots.

To tackle the problem of online ticket robots and change the economics for scalpers employing them, a web-based proof-of-work mechanism issues client-specific puzzles with difficulty determined as a function of the client's geographic distance from the event. Most legitimate purchases come from clients located in close geographic proximity to the event. The invention leverages modern Internet Protocol geolocation databases—which are 90% accurate in resolving the geographic location of each client to within 25 miles—and adaptively issues distant clients more difficult puzzles. In doing so, ticket purchasing networks are forced to acquire resources in close proximity to each event in order to monopolize event tickets. Unlike previous proof-of-work puzzles that require changes to end-hosts, protocols, and routers, the approach presented by the invention does not require changes to the software running on either the client or server and thus, can be readily deployed on current online ticketing applications.

For purposes of discussing the invention, it is assumed that a legitimate demand for event tickets is sufficient so that all tickets would normally be sold. As a result, the adversary's goal is to simply acquire as many tickets as possible when they become available for sale. To simplify the adversary model, it is assumed that all the tickets to the event are desirable for resale so the adversary will purchase any and all tickets given the opportunity. As a result, an adversary will always purchase the maximum number of tickets allowed per transaction, for example between 4 and 8 tickets. The term “ticket” used herein may be one or more tickets or the number of tickets allowed per transaction.

Long before tickets go on sale, the adversary establishes control of a botnet, which is essentially compromising a large number of computers attached to the Internet, or possibly leasing an existing botnet from herders. In terms of network and computation resources, each computer within the botnet is each roughly equivalent to the computers used by legitimate clients. In fact, some legitimate client computers may be compromised and unknowingly running botnet software targeting the very same event that the computer's user is interested in.

Timed to coincide with the start of the ticket sale (i.e., time t=0), the adversary directs the botnet to execute as many ticket purchasing transactions as possible. Since the adversary intends to use the botnet to buyout multiple events or launch other network attacks, the adversary is careful to operate the botnet in a fashion that neither alerts the online ticket vendor of the illegitimate purchase requests nor alerts the true users of the physical computers as to their misuse.

For any popular event, there is a population of legitimate clients (i.e., dedicated die-hard fans) who also attempt to purchase tickets at the moment they go on sale. To simplify the evaluation of the invention, the number of legitimate clients represent an equal number of tickets on sale (i.e., Tickets=|C|) so that the event would sell-out shortly even without the presence of ticket purchasing robots. This reasons that any ticket purchased by an adversary is one that would have otherwise been sold to a legitimate client. In practice, this does not overly weaken the adversaries since adversaries target extremely popular events to minimize the risk of purchasing tickets which cannot be easily resold later at a markup.

Online ticket vendors currently track the network addresses of successful ticket purchasers and restrict each address to one purchase per event. As a result, hosts that are behind a certain network address that has already made a purchase are denied by ticket vendors. This means that any adversary who generates a large number of ticket purchase transactions must have an equivalent number of unique network addresses to successfully complete them. Consequently, this restricts the traffic of an adversary since the adversary must control the number of unique network addresses.

While the invention is discussed with respect to the online ticketing problem discussed above, it is also contemplated that geographic distance may be used as a heuristic of client legitimacy and be applicable to other network security problems. For example, online comment spam that prevalently affects articles published by regional news outlets could similarly be mitigated using geographically driven proof-of-work puzzles. Additionally, web services with localized content could primarily throttle distant clients when encountering resource consumption attacks.

In addition to online ticket sales, the present invention may be used with webmail services. It is contemplated that a user's previous geographic location when accessing webmail may drive the difficulty of a puzzle he/she might need to solve before being allowed to access webmail and further to send an email correspondence. For example, if a user account typically sends email correspondence from an IP address that is located in Portland, Oregon and then suddenly the user's account is sending email correspondence from an IP address in Athens, Greece, then the geographic anomaly is used to increase the puzzle difficulty.

The present invention and its attributes and advantages will be further understood and appreciated with reference to the detailed description below of one contemplated embodiment, taken in conjunction with the accompanying drawings and the claims.

### BRIEF DESCRIPTION OF THE DRAWINGS

FIG. 1 illustrates a CAPTCHA according to the prior art;

FIG. 2 illustrates the performance of a ticket server throughput across a range of tasks according to the invention;

FIG. 3 is a graph illustrating the probability that the server and clients may purchase a ticket versus their distance from the event according to the invention;

FIG. 4 illustrates the population of the twenty-five largest United States metropolitan areas and how many simulated events occur in each according to the invention;

FIG. 5 is a graph illustrating the percentage of total tickets acquired by adversaries versus their ratio to clients using various geographic distributions according to the invention;

FIG. 6 is a graph illustrating the probability a client may purchase a ticket versus their distance from the event, using large legitimate client and adversary populations according to the invention;

FIG. 7 illustrates the percentage of total tickets acquired by the populations as illustrated in FIG. 6 according to the invention;

FIG. 8 is a graph illustrating the percentage of total tickets acquired by adversaries versus the ratio of adversaries to clients using various difficulty functions according to the invention; and

FIG. 9 illustrates an interface for use with webmail services according to one embodiment of the present invention.

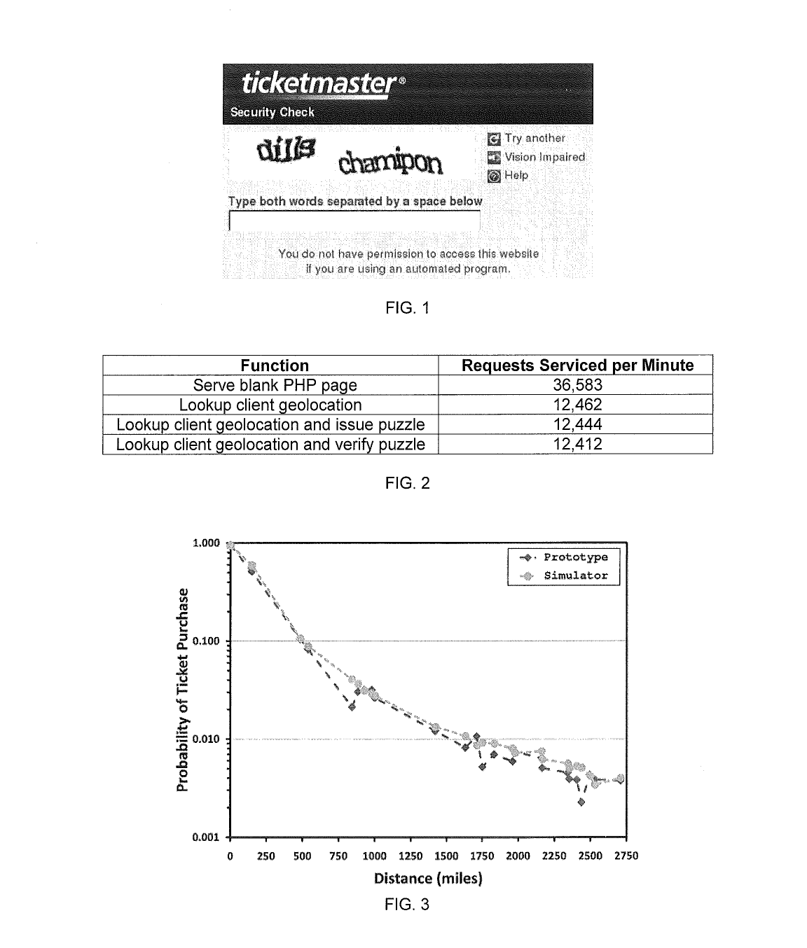

### DETAILED DESCRIPTION OF EMBODIMENTS OF THE INVENTION

The invention is discussed herein with respect to two embodiments for exemplary purposes only. The first embodiment is directed to a proof-of-work puzzle relating to online ticket sales including those that employ purchasing robots. The second embodiment is directed to a proof-of-work puzzle directed to webmail and those services that are subject to spam. The proof-of-work puzzle according to the invention may be based on at least one component including a time component, location component, reputation component, usage component, content component, and social networking component, and may further be applicable to a wide variety of web transactions and applications.

According to the invention, there are two fundamental components to the proof-of-work puzzle: the proof-of-work mechanism and the geographic policy that configures the proof-of-work mechanism. According to the exemplary embodiment of the invention described below, the policy that configures the proof-of-work mechanism is a geographic policy.

Proof-of-work mechanisms consist of three subcomponents: a server-side issuer that creates and delivers a puzzle to the client, a client-side solver that generates and returns a puzzle solution to the server, and a server-side verifier that denies or accepts solutions based on validity. An obstacle to the deployment of proof-of-work puzzles within computer systems is that they require modifications to end hosts, network protocols, or routers. One proof-of-work puzzle that requires few changes to the computer system is known as mod_kaPoW, which is deployed by simply loading an Apache module. The module transparently attaches puzzles to Uniform Resource Locators (“URL”s) within served HyperText Markup Language (“HTML”) documents and supplies clients with a JavaScript solver. The Apache module verifies that correct answers accompany all subsequent client requests.

The proof-of-work mechanism of the invention is similar, but rather than use an Apache module, the issuer and the verifier are implemented in Hypertext Preprocessor (“PHP”) language, a ubiquitous web scripting language. This requires no changes to the web server so it may even be used by websites that cannot load Apache modules. The invention continues to leverage the targeted hash reversal puzzle construction and a periodically updated server secret K to generate client nonces via the block cipher encryption of the client Internet Protocol (IP) address: E_{K}(IP_{c}). The server protects the URL to purchase a ticket by specifying the client-specific difficulty D_{c} so the JavaScript solver must find a solution S such that

H(E_{K}(IP_{c})∥URL∥S)mod D_{c}=0 (1)

where H is a pre-image resistant cryptographic hash function. The solver must perform a brute-force search to find a value for S satisfying the equation. Using a hash function which uniformly distributes its output, the probability that any given S satisfies the equation is

$$\frac{1}{{D}_{c}} ,$$

and the number of attempts required to find a valid solution are geometrically distributed with a mean of D_{c}.

The goal of any proof-of-work mechanism is to maximize the amount of work that adversaries must perform while simultaneously minimizing the work imposed upon legitimate clients. A key observation is that most legitimate purchasers of event tickets do so in close geographic proximity to where the event takes place. Given that commercial geolocation databases which map IP addresses to their geographic location have become very accurate, proof-of-work puzzles whose difficulties are driven by geographic distance can limit scalping by forcing potential purchasers to perform work that commensurate to the distance they are away from the actual event. Adversaries must then physically own significant resources near event centers in order to monopolize ticket purchases, thereby making scalping much more costly than simple CAPTCHA outsourcing.

To evaluate the invention, accurate commercial geolocation databases are leveraged to ascertain d_{c}, the distance of a given client from the event. This distance is then used to set the difficulty D_{c} of the puzzle that must be solved by that client before being able to purchase a ticket. To determine how to best set the difficulty, a number of policies are explored and evaluated with respect to the ability to thwart a large number of adversaries. Specifically, the number of tickets purchased by the legitimate clients C who intend to attend the event are maximized while the number of tickets purchased by the adversaries A who intend to purchase tickets for resale are minimized.

One embodiment was implemented that leverages MaxMind's mod_geoip. This embodiment consists of a single PHP script that attaches a puzzle to the link for the ticket-purchasing page, validates subsequent solutions, and only allows clients with valid solutions to access the ticket-purchasing page. FIG. 2 shows the baseline performance of the embodiment on an Intel Core 2 Quad system (Q6600/2.4 GHz) running Apache 2.2.9 on Fedora Linux. As FIG. 2 shows, the server processes over 36,000 blank PHP pages a minute. When IP address resolution is added, the throughput of the computer system drops by two-thirds due to the overhead of looking up the IP address in the geolocation database. The cost of issuing and validating proof-of-work puzzles is negligible compared to that of geolocation resolution. The performance is more than adequate to support the ticketing application as the capacity of most venues is below the amount of requests the server can process in a minute.

The prototype above shows how geographic proof-of-work can be easily added to the online ticketing application. To show the invention can mitigate realistic networks of ticket-purchasing robots, however, large-scale experimentation using thousands of robots should be performed. Since such experimentation is impractical, a simulator that includes a simulated server and simulated clients closely models the behavior of the prototype server and its clients. To validate that the simulator accurately represents the implementation, the results of the following small-scale experiment on the prototype are compared to the identical experiment in the simulator.

The experiment consists of an event in a city on the west coast of the United States—Los Angeles, Calif.—for which 100 legitimate clients and 100 adversaries attempt to purchase the 100 available tickets. While the legitimate clients are all located near the city, adversaries are randomly distributed across the 25 largest metropolitan areas in the United States in proportion to the size of each area. As described in above, this distribution maximizes the adversaries' ability to acquire tickets across all events held across the country. Driving the proof-of-work mechanism, the puzzle difficulty is set as D_{c}=100 d_{c}²+10⁶; alternate embodiments directed to setting puzzle difficulty are discussed below.

The experiment was performed 10,000 times, both on the prototype and in simulation. FIG. 3 shows the probability that clients and adversaries successfully purchase tickets to an event as a function of their distances from the event. As FIG. 3 shows, the results from the simulator closely match those from the actual prototype with local clients having an exponentially higher probability of purchasing a ticket than their distant peers.

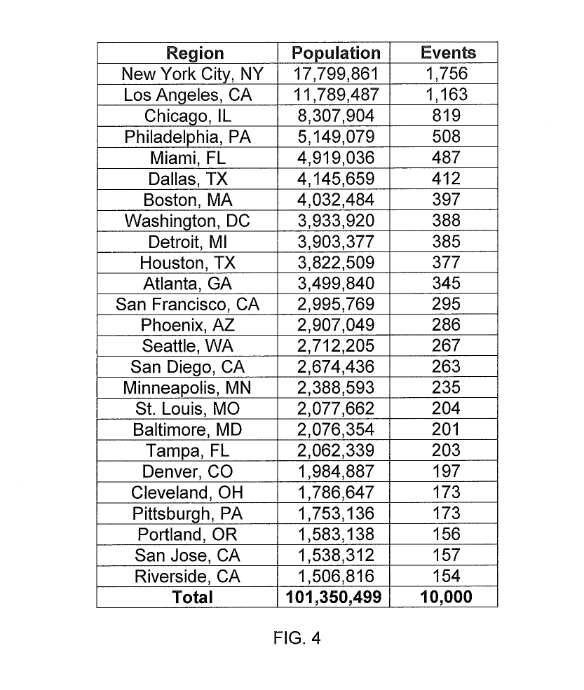

Similar to real-world ticket outlets, the simulated server sells tickets to events throughout the 25 largest metropolitan areas in the United States with events occurring in proportion to the population of each area. The remainder of this evaluation investigates the ability of an adversary network to purchase tickets to the 10,000 events shown in FIG. 4.

Geographic distribution strategies are explored in which the adversary network might take to maximize its success. In each experiment, an event location is selected and 2,500 local clients attempt to purchase 2,500 tickets. The adversary population is exponentially increased to determine the percent of the total tickets that can be purchased. Once again, the difficulty algorithm is D_{c}=100 d_{c}²+10⁶.

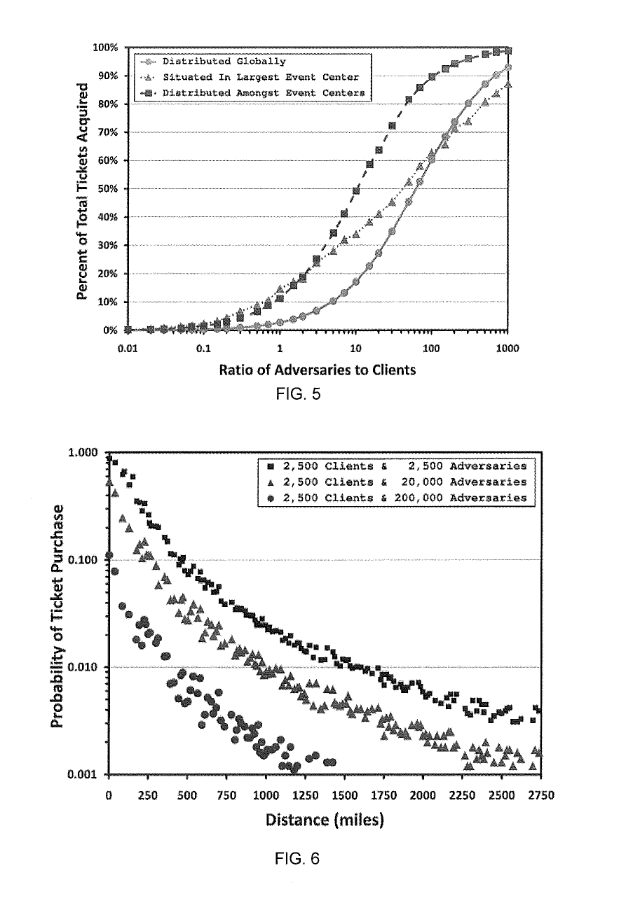

FIG. 5 shows the success of three strategies for distributing adversaries. The first approach assembles adversaries all around the globe like a nave botnet might. Adversary IP addresses were obtained from the 10,000 worst daily offenders reported by DShield. Not surprisingly, this approach requires orders of magnitude more adversaries than other approaches because many of the bots are far away (i.e., not in North America) from where events are held.

In the second approach, all adversaries are situated in the largest event center: New York City. Acquiring tickets to events in that area is easy, however, acquiring tickets to events held in other areas remains challenging—they must get “lucky” when solving their puzzles to have a chance to purchase tickets before local legitimate clients do.

The third approach distributes adversaries throughout the 25 largest areas in the United States in proportion to their population. This simulates the repeated or long-term leasing (from a botnet controller) of only those zombie computers that are geographically desirable to at least one event location. In this approach, each adversary is local to at least some events and on average 5.96% of the adversaries are local to a randomly selected event. Of the three adversary approaches, this third approach performs the best, particularly in purchasing the last (i.e., highest) percentile of tickets, and is selected for subsequent experiments.

The experiments discussed above qualitatively demonstrate the ability for geographic proof-of-work to slow down an adversary. To quantify the extent at which this is the case, the performance of the system is simulated as the number of adversaries is steadily increased. Adversaries are distributed across the 25 largest metropolitan areas as before and the difficulty algorithm is again calculated as D_{c}=100 d_{c}²+10⁶.

FIG. 6 shows the ability of individuals to purchase tickets with respect to their distance from the event as the population size of adversaries is changed. As expected, a client's purchasing ability decreases the further away it is from the event location so local clients stand a much better chance of acquiring tickets. In addition, as the number of total clients is increased, the probability of successfully purchasing a ticket drops across all distances simply because there are more individuals competing for the same finite number of tickets.

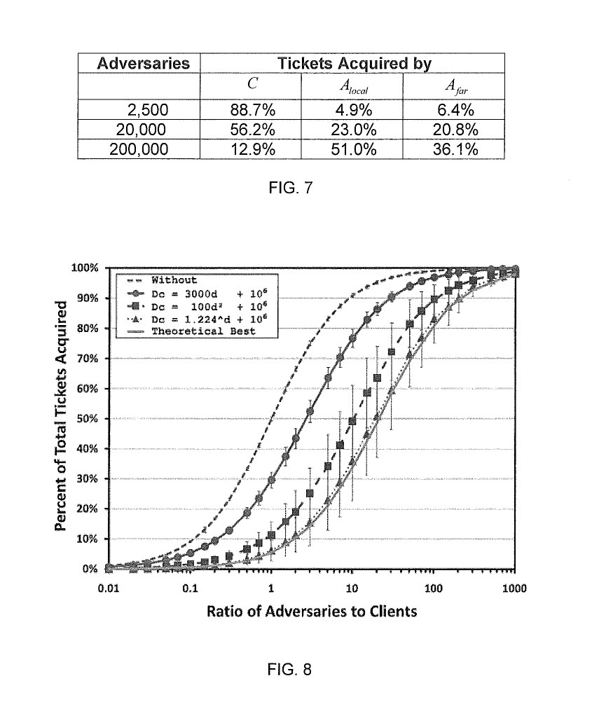

As the adversary population is increased significantly versus the legitimate client population, larger numbers of local adversaries A_{local} begin to compete with the legitimate clients. This decreases the percentage of tickets that go to legitimate clients as an increasing percentage of tickets are acquired by adversaries, as shown in FIG. 7 with the client population (and thus tickets) equal to 2,500.

While the adversary network as a whole acquires more tickets across all events, for any specific event, non-local adversaries A_{far} are largely unsuccessful. With increased distance, adversary effectiveness quickly drops off. This is particularly evident in FIG. 6 when the 200,000 adversaries outnumber the 2,500 clients (and thus tickets) by a ratio of 80 to 1; adversaries beyond 1,500 miles have less than a 1% chance to acquire tickets. As the adversary population increases, individual local adversaries also have a diminished ability to purchase tickets because they are competing amongst themselves (not just legitimate clients) for the limited tickets.

Throughout the 10,000 events on average 11,872 of the 200,000 adversaries are local to any given event. The local adversaries roughly represent 5.96% of the total adversary population yet account for 58.6% of tickets acquired by the entire adversary population (51.0% of all tickets sold). On average 94.04% (118,128) of adversaries are non-local and manage to purchase only 36.1% of total tickets. The adversary network's success comes at a great cost as 98.9% of the individual adversaries have nothing to show for their arduous proof-of-work computation.

As described above, a single difficulty algorithm is used for determining the amount of work a client must perform as a function of its geographic distance from the server. To examine the sensitivity to this algorithm, a number of alternatives are examined. In comparing more than one difficulty algorithm, the worst-case and best-case scenarios are derived. The worst-case scenario occurs when the server operates without proof-of-work puzzles. Assuming that clients and adversaries arrive to purchase tickets at approximately the same time, the percentage of total tickets that the adversaries are expected to acquire is:

$$without \approx \frac{\vert A \vert}{\vert A \vert + \vert C \vert} \qquad ( 2 )$$

Conversely, the best-case scenario occurs when the computer system denies all non-local adversaries so that only local adversaries A_{local} compete with legitimate clients for the tickets. The percentage of total tickets that the adversaries are expected to acquire is:

$$theoretical best \approx \frac{\vert {A}_{local} \vert}{\vert {A}_{local} \vert + \vert C \vert} \qquad ( 3 )$$

FIG. 8 demonstrates the effectiveness of three different difficulty algorithms on impeding adversaries with respect to the theoretical bounds described above. The algorithms shown are: linear (D_{c}=3000 d_{c}+10⁶), degree 2 polynomial (D_{c}=100 d_{c}²+10⁶), and exponential (D_{c}=1.224^{d}^{_{c}}+10⁶). The above theoretical bounds are shown in FIG. 8 as well.

The average client delay (in seconds) for these functions closely follows the difficulty divided by the number of hashes computable in one second

$$( i . e . , \frac{{D}_{c}}{1 , 000 , 000} ) .$$

Thus, for these functions the delay is roughly one second for legitimate clients (due to the 10⁶ constant) and quickly grows to minutes for distant adversaries. As FIG. 8 shows, minimal geographic differentiation is needed to give clients noticeable advantage, yet with slightly more aggressive differentiation the system quickly nears the theoretical best curve. Using the linear difficulty algorithm, remote adversaries are delayed on the order of tens of seconds. In contrast, the polynomial algorithm ramps up the difficulty so that distant adversaries across the country (3,000 miles away) are delayed several minutes. The exponential algorithm is much more severe and delays adversaries further than 100 miles away by several minutes. The three algorithms impede adversaries such that the adversaries must multiply their population size by a factor of 2.72, 10.4, and 19.2 (for the respective linear, polynomial, and exponential algorithms) to acquire the same percentage of tickets as a server operating without a geographic proof-of-work puzzle.

The probabilistic nature of puzzle solving means that in some experiments adversaries get “unlucky” and do worse than the theoretical best equation dictates (as evidenced by the error-bars reaching below the theoretical best curve). Conversely, sometimes adversaries get “lucky” when solving their puzzles and thus get more tickets than expected.

While geographic proof-of-work puzzles increase the monetary cost to adversaries by forcing them to have a presence near each event, there are two problems with using IP-based geolocation databases. The first problem is that non-local and erroneously geolocated legitimate clients will be unfairly penalized. The second problem is that for small events in large event centers, the cost of obtaining sufficient unique local computers to monopolize the event tickets may not be high enough to deter automated ticket purchasing.

It is important that the policy itself adapts to the counter-measures employed by the adversary. A contemplated modification to the policy uses the credit card's geographic billing address when determining the difficulty of the proof-of-work puzzle. Clients must already provide authentic credit card information including the billing address in order to purchase tickets. Using that information, the system would have another method for determining where clients are geographically purchasing event tickets from, one which is possibly harder to spoof. This would increase adversary operating costs by forcing them to obtain and maintain a large number of unique local credit cards for every event center targeted.

Proof-of-work puzzles force clients to commit computational resources before they may proceed with the ticket purchasing transaction. One might consider using geographic locations alone without proof-of-work puzzles to avoid the client's resource commitment. For example, ticket vendors could alternatively sell tickets probabilistically at different times based on the client's geographic distance to the event. However, those methods lack certain benefits of using proof-of-work puzzles according to the invention.

First, proof-of-work puzzles deter an adversary from using a single computer to launch multiple requests. If tickets were sold probabilistically based on client distance, an adversary would simply flood the vendor with requests until successful. With proof-of-work puzzles, the adversary gains little benefit from flooding requests since the challenge must still be solved before a request is granted. Additionally, proof-of-work puzzles prevent an adversary from using a single computer to participate in concurrent ticket purchasing campaigns—or attack other network protocols protected by proof-of-work puzzles—since solving simultaneous proof-of-work puzzles simply slows down the solution of each rather than providing an advantage.

Second, proof-of-work puzzles increases the likelihood that any individual botnet computer will be discovered and repaired. Aggressive adversaries using distant computers to purchase tickets will incur steep computational penalties which may make individual computers unresponsive to the real users. This increases the chance that the user of the computer will investigate the system degradation and fix it (i.e., remove the zombie software). The risk of detection and removal will thus deter adversaries from targeting ticket vendors protected by proof-of-work puzzles. Likewise, adversaries using local zombie computers also increase the risk of being discovered when conflicting with the legitimate users also attempting to purchase tickets to the event. Since the ticket vendor allows only one transaction per network address, two outcomes are possible. If the legitimate user completes their transaction first the adversary cannot complete a transaction with that computer. On the other hand, if the zombie completes their transaction first the legitimate user will get an error message claiming that they have already purchased a ticket to the event increasing the chance that the user of the computer will discover the zombie software and remove it.

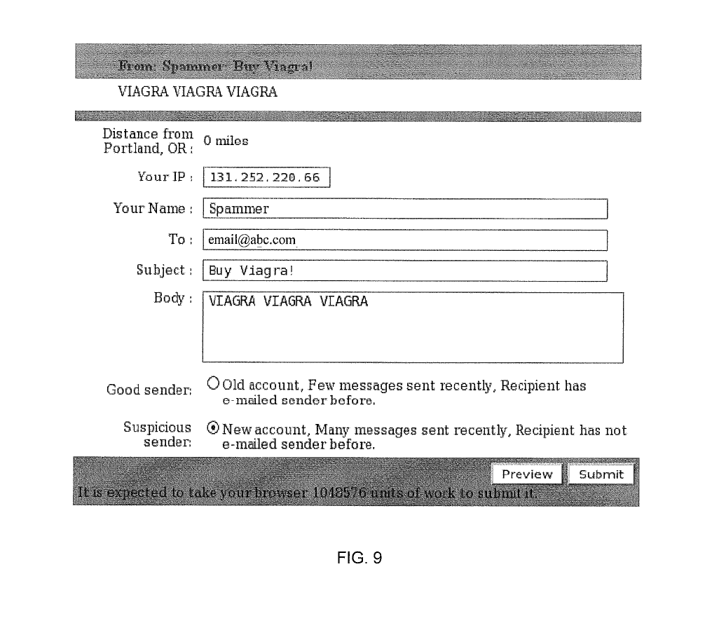

Online ticket outlets currently employ CAPTCHAs to slow down fully automated ticket-purchasing scalper networks. Unfortunately, intelligent adversaries sidestep CAPTCHAs by outsourcing them to humans for less than a penny per solution. This highlights their weakness in protecting the ticketing application: the cost for solving those using humans is small and fixed. One embodiment of the invention relies on the observation that most legitimate clients are located in close geographic proximity to an event. Leveraging accurate IP geolocation databases, a computer system assigns client-specific puzzles that are increasingly more difficult the further away a client is from the event. In an embodiment to thwart spammers while preserving service to legitimate webmail clients, a web-based email transmission service is written completely in the scripting language known as PHP that delivers a JavaScript solver to the client for solving the modified time-lock puzzles. The system does not require modifications to either the web server or the web client software. The present invention leverages OpenSSL at the server to efficiently generate the modulus used in the modified time-lock algorithm and employs a geographic database when the location component is enabled. By default, a user's message is run through SpamAssassin, checks the URLs and domain names within the message against two blacklists, checks the user's IP address against blacklists such as Spamhaus, SpamCop, Project HoneyPot and computes the geographic distance the user's IP address is away from the server's. Based on these checks, an overall score is generated to determine puzzle difficulty. FIG. 9 shows a screenshot of an interface for use with webmail services according to one embodiment of the present invention.

One of the key components of the present invention is the modified time-lock algorithm that issues multiple puzzles using a single modulus n. The modulus is computed via the generation of two large prime numbers. The modified time-lock algorithm amortizes the overhead of generating two large prime numbers by issuing multiple time-lock puzzles using a single modulus. This is done by generating the puzzle parameter a as a cryptographic hash of a periodically updated random server nonce K and client parameters such as the URL being requested, the client's IP address, and the difficulty of the puzzle issued. Creation of a new puzzle is thus limited by the speed the cryptographic hash can be done in PHP. The standard SHA1( ) function is used to generate a. Issuing a modified time-lock puzzle is many orders of magnitude faster than using the unmodified time-lock puzzle algorithm.

The final piece of the modified time-lock algorithm is the verification of answers. The verification procedure is the same as the original time-lock algorithm with one addition. The verifier must validate that the parameter a matches the client's request by recalculating the SHA1( ) function on K and the client parameters. The main overhead in verification is performing the shortcut computation by calculating r=2^{t} mod φ and A′=a^{r} mod n. The client solver is written in JavaScript and leverages a Big Integer Library to perform the modular squaring with arbitrarily large integers. The key component for the solver is the amount of time a client consumes to perform an operation.

The present invention applies a defense-in-depth approach against the problem of webmail spam. Rather than use a single detector such as the content of the message or the recent request rate of the client, it uses a comprehensive set of metrics for determining the difficulty of puzzles that clients must solve. This is important for properly identifying and penalizing misbehavior while allowing legitimate use to go through. Difficulties are set by applying individual tests against the message being sent and the client sending it. These tests are aggregated into a single score that is then used to generate the difficulty.

Considering the scenario of a webmail interface for a university. Such systems are under constant threat of spear phishing attacks where adversaries obtain legitimate account credentials and use them to send large amounts of spam via bots. To address these attacks, a scoring algorithm is used across all components: time, usage, location, reputation, content, and social network. For each component, a binary test is used to indicate whether the activity is suspicious or not. For example, the individual tests used for each component are:

Time (Sₜ): Does the current time of day fall within an 8-hour window during the day that users typically send email?

Usage (Sᵤ): Has the user account sent a message within the last 5 minutes?

Location (Sₗ): Is the geographic location of the IP address of the client within 500 miles of the institution?

Reputation (Sᵣ): Does the IP address of the client appear on any blacklists?

Content (S_{c}): Does SpamAssassin consider the message spam?

Social network (Sₛ): Does the recipient of the message appear in the user account's address book?

Using these metrics, the algorithm generates an overall score by summing the individual tests up resulting in a score from 0 to 6:

score=Sₜ+Sᵤ+Sₗ+Sᵣ+S_{c}+Sₛ

From this score, the difficulty of the modified time-lock puzzle issued to a client is set as:

t=20×score⁶

Thus, the range of t goes from 0 to 933,120, which corresponds to client solution times of 0 seconds to 18,662 seconds as measured. Given this, a range of bots attempting to send as much spam as possible through the webmail interface using the compromised account is simulated. It is assumed that bots send messages that are classified correctly by SpamAssassin with 80% success (i.e. S_{c}=1 for 80% of the messages). They also send messages to recipients that are not in the user's address book (Sₛ=1). The experiment also simulates a legitimate user attempting to send a message that is not classified as spam (S_{c}=0), to someone in his/her social network (Sₛ=0), during regular hours (Sₜ=0), at a local location (Sₗ=0), on a machine whose IP address does not appear on a blacklist (Sᵣ=0). With this setup, the only potential penalty against the legitimate user is the usage component Sᵤ, as the adversary has hijacked the account and has been sending messages throughout the day on it. Bots that are local and have IP addresses with good reputations are able to send the most messages through the service. However, since they are sending messages that are likely to be classified as spam, to recipients that are not in the user's social network, at a rate that will trigger the usage component, and during times of day that are abnormal, they are eventually given puzzles with significantly higher difficulty and are forced to slow down. For bots that are not local or that have IP addresses that appear on blacklists, the penalty is even steeper and they send substantially fewer messages. Finally, the table lists the average delay the legitimate user experiences when attempting to send a message. While the adversary is impacted significantly, the legitimate user experiences a nominal delay in sending a message.

Thus, while a multitude of embodiments have been variously described herein, those of skill in this art will recognize that different embodiments show different potential features/designs which can be used in the other embodiments. Even more variations, applications and modifications will still fall within the spirit and scope of the invention, all as intended to come within the ambit and reach of the following claims.

What is claimed is:

1. A computer system method for efficiently issuing and validating multiple computational puzzles from a single puzzle, comprising the steps of:
(a) providing by the server two large prime numbers p and q;
(b) calculating by the server φ=(p−1)×(q−1)
(c) determining by the server n=p×q;
(d) figuring by the server r=2^{t} mod φ, wherein t is set to f_{c}( ) that is a client-specific difficulty generation function that determines how much work the given client should perform before being given access to information;
(e) generating by the server a as a cryptographic hash of client-specific characteristics and a periodically updated random server nonce, K;
(f) sending by the server to the client a, t, and n;
(g) computing by the client A=a^{(2̂t)} mod n;
(h) checking by the server the answer from the client using a shortcut A′=a^{r} mod n
if A′=A, then accept answer; and
(i) granting the client access to information.

2. The computer system method for efficiently issuing and validating multiple puzzles from a single puzzle according to claim 1, wherein a=SHA1(K f_{c}( )) where f_{c}( ) can consist of any number of client parameters including the URL being requested, the IP address of the client, and the difficulty of the puzzle given to the client.

3. A computer system method for setting the difficulty of any computational puzzle that a client must solve before granting access to information, wherein the computational puzzle difficulty t is based on at least one component selected from the group of components comprising of: time component, location component, reputation component, usage component, content component, and social networking component.

4. The computer system method for setting the difficulty of a computational puzzle that a client must solve before given access to information according to claim 3, wherein the time component is one or more selected from the group of: the time elapsed since the creation of an account by the client on the web service, the time elapsed since the last request of the client, the time of day a request or message is sent, the difference in time the request or message is sent by the client and the typical time of day the client sends requests or messages, and the difference between the current time and a fixed time in the past or in the future.

5. The computer system method for setting the difficulty of a computational puzzle that a client must solve before given access to information according to claim 3, wherein the location component is one or more selected from the group of: the geographic location of the client, the geographic distance from the client to the server, the geographic distance from the client to other users, the geographic distance from the client to other fixed geographic locations, and the geographic distance from the client's current location to a client's typical location in accessing a site.

6. The computer system method for setting the difficulty of a computational puzzle that a client must solve before given access to information according to claim 3, wherein the reputation component is one or more selected from the group of: the reputation of the source Internet Protocol address the client is using as determined by other network entities that have interacted with it previously, and the reputation of the client itself as determined by other clients.

7. The computer system method for setting the difficulty of a computational puzzle that a client must solve before given access to information according to claim 3, wherein the usage component is one or more selected from the group of: the number of recipients the message or request will cause to be contacted, the number of requests or messages the client has sent over an arbitrary time period in the past, the current load on the entire computer system, and the number of messages the client has sent through their account that have not been classified as spam compared to the number of messages the client has sent through the account that have been classified as spam.

8. The computer system method for setting the difficulty of a computational puzzle that a client must solve before given access to information according to claim 3, wherein the content component is one or more selected from the group of: the format or structure of the message that the client is attempting to send, the reputation of Uniform Resource Locators (URLs) embedded in the message that the client is attempting to send, or the reputation of an image embedded in the message that the client is attempting to send.

9. The computer system method for setting the difficulty of a computational puzzle that a client must solve before given access to information according to claim 3, wherein the social networking component is one or more selected from the group of: whether the client is in the social network of the eventual recipient of the content and the social distance the client is away from the recipient, the reputation of the client in the social network of the recipient as determined by the recipient and the recipients peers, and whether the eventual recipient of the content of the request or message of the client has previously communicated with the client in the past.
